(19) United States
(12) Patent Application Publication
(10) Pub. No.: US 2016/0360931 A1
(43) Pub. Date: Dec. 15, 2016

(54) CONTAINER HOLDER

(71) Applicant: Proyecciones Cinematograficas Alhsur SL, La Zubia (Granada) (ES)

(72) Inventors: Jacob FERNANDEZ MORANTE, La Zubia (Granada) (ES); David ILARDUYA CANALES, La Zubia (Granada) (ES); Javier MACHIMBARRENA GUERRICA-ECHEVARRIA, La Zubia (Granada) (ES)

(21) Appl. No.: 14/827,724

(22) Filed: Aug. 17, 2015

(30) Foreign Application Priority Data
Jun. 9, 2015 (ES) 201530672

(51) Int. Cl. A47J 47/14; B65D 71/52

(52) U.S. Cl. CPC A47J 47/14; B65D 71/0003

(57) ABSTRACT

A container holder, which is constituted from a “T”-shaped flat template having a central section (1) and two lateral sections (2 and 3). The central section (1) presents two longitudinal bending lines (4), which delimit an intermediate area (5), along which two openings (7 and 8) are made with an outline similar to that of the containers to be transported, and two end strips (6) which are equal and of less width than the intermediate area. The lateral sections (2 and 3) stand out in opposite directions from the central section (1), into facing positions and aligned with one of the openings (8) of the central section.

### CROSS REFERENCE TO RELATED APPLICATION

This Application claims the priority of Spanish Patent Application No. 201530672 filed on Jun. 9, 2015, application which is incorporated herein by reference.

### TECHNICAL FIELD

The present invention relates to a container holder, intended to provide a person with the transport of ingestible product containers and which, generally, require the intervention of the consumer's two hands for holding and transportation thereof.

The container holder of the invention is specially made so that a person can with one hand, safely and comfortably carry, a container with solid food products, such as popcorn, potato chips, etc., and a container with a drink.

### BACKGROUND OF THE INVENTION

In many common situations, it is frequent that attendees to certain shows or establishments acquire, when entering the premises where the show is being performed, certain food products and/or drinks, each arranged in the corresponding container, which are to be transported by the consumer in the hands.

If these products are to be taken out of the point of sale or establishment in which they are acquired, the consumer must use both hands for the transport of the containers, with the consequent disadvantages which that may cause when having to perform other activities.

The explained situations arise, for example, in cinemas, where the acquisition of drinks and popcorn for consumption during the screening is common Usually at the entrance of these screening rooms are shops that sell these products in different formats to the public, which are contained in appropriate containers.

The offered soft drinks are for example packed in containers of plastic coated paper, or similar, of various sizes, as are solid food products, such as popcorn, which are usually transported each container in a hand to the inside of the screening room, with the discomfort this entails for the user, with both hands occupied, apart from the risk of container falls, with the considerable cleaning work that this implies for cinema staff.

To avoid this problem, containers or packages with products purchased can be transported in rigid flat trays on which the stability of the containers is difficult to achieve.

For the same purpose, trays, which have conformations adapted to the shapes of the containers in which food products and beverages are sold, are known. These trays are of rigid nature, of relatively high cost and, therefore, they tend to be returnable trays for successive uses.

### DESCRIPTION OF THE INVENTION

The object of the present invention is a container holder constituted so that it solves the problems posed, since it allows for the transportation of at least two full containers, such as one containing a solid food product and the other containing a drink, all in a safe way from the point of purchase to the location where they are to be consumed.

Another object of the invention is to provide a container holder of simple constitution and low cost, so it is a disposable item, thus eliminating all the problems posed by the returnable products.

Yet another object of the invention is to provide a support that facilitates the placement of the containers in the container holder.

According to the invention, the container holder consists of a “T”-shaped template, with a central section and two lateral sections perpendicular to the central section.

The central section presents two longitudinal folding lines that delimit an intermediate zone and two equal external strips. Two openings, whose outlines correspond to that of the containers to be transported, are made in the central area. The end strips are of lesser width than the intermediate area.

The lateral sections protrude perpendicularly from the central section, in opposite directions, aligned with one of the openings in the intermediate area, preferably aligned with the opening intended to receive the container with the contents of greater weight. These sections have, near their ends, two equal windows, placed at the same distance from the central section.

The openings in the central area can be one with a square outline and the other with an approximately circular outline, for transporting a container of polygonal outline, for example with a square outline and containing solid food products, such as popcorn, and a container with a circular outline with a drink, in the form of a glass.

With the container holder of the invention, after introducing the containers through the corresponding openings in the intermediate area of the template, the side arms are folded from the folding lines that separate them from the intermediate area, towards the side where the open base or mouth of the containers is, until these sections are attached at their ends, with their windows in a matching position, to serve as handles of the assembly.

In order to facilitate the positioning of the containers into the openings of the container holder, a positioning support can be used, which consists of a rectangular frame, with the same outline as the central area of the template that makes up the container holder. A longitudinal protrusion stands out from one of the smaller sides of the frame through one of the surfaces of said frame.

The template is arranged flat on the support for placement of the containers in the container holder, with the central section on the frame, by supporting the cross edge of said section on the longitudinal protrusion of the frame, thus the openings being over the outline limited by the frame, in a position to receive containers to be transported, then folding the wings, whose windows will serve as a handle for the transport of the assembly.

### BRIEF DESCRIPTION OF THE DRAWINGS

The attached drawings show, by way of non-limiting example, a container holder constituted according to the invention, wherein:

FIG. 1 is a view of the template from which the container holder is formed.

FIG. 2 is a perspective view of the container holder with the containers included.

FIG. 3 is a perspective view of the template in FIG. 1 located on a positioner support.

FIG. 4 is a perspective view of the template engaged on the positioner support.

### DETAILED DESCRIPTION OF THE INVENTION

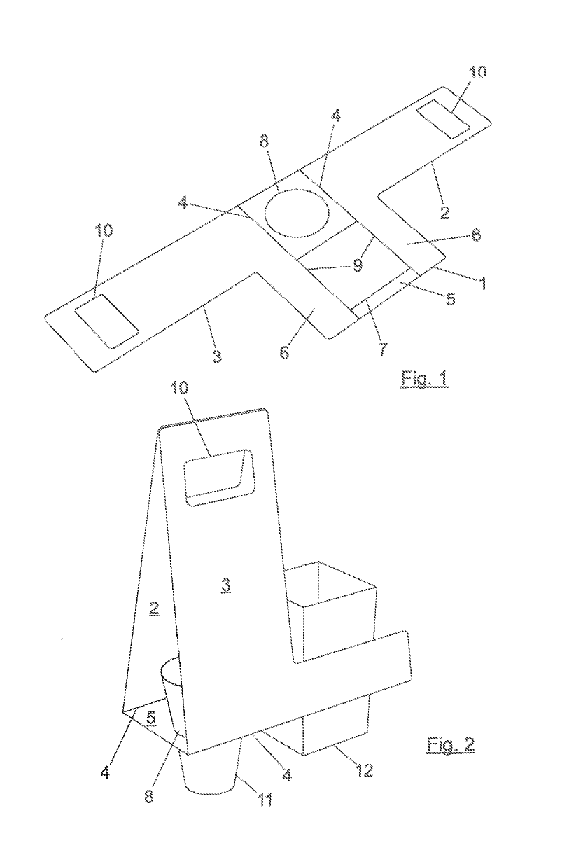

FIG. 1 shows the development of a template from which the container holder of the invention is formed.

This template has a “T”-shaped outline, with a central section (1) and two equal lateral sections (2 and 3), which protrude perpendicularly to the central section (1) in opposite directions.

The central section (1) has two longitudinal folding lines (4) that delimit an intermediate area (5) and two end strips (6).

Along the intermediate area (5) two openings (7 and 8) are made, the first one with a square outline and the second one with a circular outline, in the represented example with two of the opposite edges (9) of the opening (7) being placed matching with the folding lines (4).

The lateral sections (2) have, near their ends, two equal windows (10), placed at the same distance from the central section (1).

Preferably the lateral sections (3) will be aligned with the opening (8) with a circular outline, intended to receive a container a glass containing a drink, while the opening (7) will receive a container with an edible, less heavy, solid product such as popcorn.

FIG. 2 shows a glass (11) housed in the opening (8) and a container (12) with a square outline placed into the opening (7). The sections (2 and 3) are folded, starting from the folding lines (4), towards the side where the mouths of the containers (11 and 12) are located, until their ends abut, with the windows (10) matching to serve as handles for the assembly.

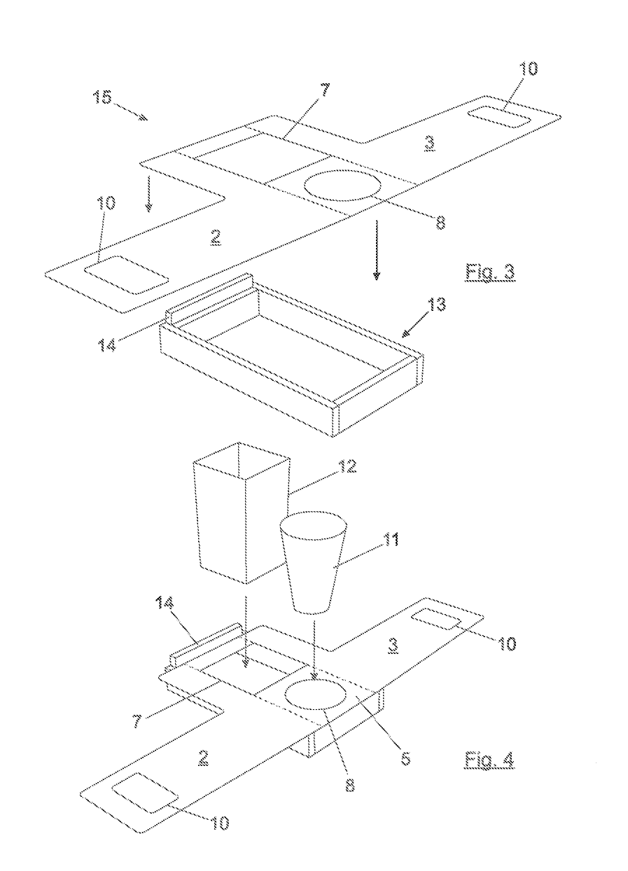

The placement of the containers (11 and 12) in the container holder is facilitated by the use of a support (13), FIG. 3, in the form of a frame of rectangular outline, with a longitudinal protrusion (14) along of its smaller sides. This support can also be formed from a cardboard template or be of rigid and resistant nature.

As shown in FIGS. 3 and 4, the template (15) of the container holder is located on the frame (13), with the intermediate area (5) in centred position, so that the openings (7 and 8) are on the outline delimited by the frame, with the free cross edge of the central section (1) resting on the longitudinal protrusion (14).

Then the containers (11 and 12) are placed into the corresponding openings (7 and 8) and the lateral sections (2 and 3) are folded upwards, to the position in FIG. 2, ready for transport.

1. A container holder, comprising a “T”-shaped flat template, with a central section and two lateral sections, whose central section presents two longitudinal bending lines, which delimit an intermediate area, along which two openings are made with an outline similar to that of the containers to be transported, and two end strips which are equal and of less width than the intermediate area, and whose lateral sections stand out in opposite directions from the central section, into facing positions and aligned with one of the openings of the central section.

2. The container holder according to claim 1, wherein the intermediate area has two openings, one opening with a square outline and another opening with an approximately circular outline.

3. The container holder according to claim 1, wherein the lateral sections have, near their ends, two equal windows, placed at the same distance from the central section.
